(19) United States
(12) Patent Application Publication
(10) Pub. No.: US 2023/0375458 A1
(43) Pub. Date: Nov. 23, 2023

(54) PARTICLE SORTER NOZZLES AND METHODS OF USE THEREOF

(71) Applicant: Becton, Dickinson and Company, Franklin Lakes, NJ (US)

(72) Inventors: Jrhung Tsai, Alameda, CA (US); Raymond Cota, San Jose, CA (US)

(21) Appl. No.: 18/138,301

(22) Filed: Apr. 24, 2023

Related U.S. Application Data
(60) Provisional application No. 63/342,724, filed on May 17, 2022.

(51) Int. Cl. G01N 15/14; B01L 3/00

(52) U.S. Cl. CPC G01N 15/1404; B01L 3/502761; G01N 2015/1006

(57) ABSTRACT

Particle sorter nozzles are provided. Nozzles of interest include an elongate body, and a gas inlet radially positioned at the proximal end of the elongate body. Gas inlets of the subject nozzles include a radial airflow path configured to provide a gas to the channel. The elongate body includes an opening at a proximal end configured to engage in a liquid-receiving relationship with a flow cell, an opening at a distal end for emitting liquid droplets, and a channel configured to transport liquid through the elongate body from the proximal to the distal end. Also provided are particle sorters having the subject nozzles, methods of using and assembling the subject particle sorters, and kits.

### CROSS-REFERENCE TO RELATED APPLICATION

Pursuant to 35 U.S.C. § 119 (e), this application claims priority to the filing date of U.S. Provisional Patent Application Ser. No. 63/342,724 filed May 17, 2022; the disclosure of which application is incorporated herein by reference in its entirety.

### INTRODUCTION

Flow cytometry is a technique used to characterize and often times sort biological material, such as cells of a blood sample or particles of interest in another type of biological or chemical sample. A flow cytometer typically includes a sample reservoir for receiving a fluid sample, such as a blood sample, and a sheath reservoir containing a sheath fluid. The flow cytometer transports the particles (including cells) in the fluid sample as a cell stream to a flow cell, while also directing the sheath fluid to the flow cell. To characterize the components of the flow stream, the flow stream is irradiated with light. Variations in the materials in the flow stream, such as morphologies or the presence of fluorescent labels, may cause variations in the observed light and these variations allow for characterization and separation. To characterize the components in the flow stream, light must impinge on the flow stream and be collected. Light sources in flow cytometers can vary and may include one or more broad spectrum lamps, light emitting diodes as well as single wavelength lasers. The light source is aligned with the flow stream and an optical response from the illuminated particles is collected and quantified.

Isolation of biological particles has been achieved by adding a sorting or collection capability to flow cytometers. Particles in a segregated stream, detected as having one or more desired characteristics, are individually isolated from the sample stream by mechanical or electrical removal. A common flow sorting technique utilizes drop sorting in which a fluid stream containing linearly segregated particles is broken into drops. The drops containing particles of interest are electrically charged and deflected into a collection tube by passage through an electric field. Typically, the linearly segregated particles in the stream are characterized as they pass through an observation point situated just below the nozzle tip. Once a particle is identified as meeting one or more desired criteria, the time at which it will reach the drop break-off point and break from the stream in a drop can be predicted. Ideally, a brief charge is applied to the fluid stream just before the drop containing the selected particle breaks from the stream and then grounded immediately after the drop breaks off. The drop to be sorted maintains an electrical charge as it breaks off from the fluid stream, and all other drops are left un-charged.

Droplet formation at the nozzle tip is conventionally achieved via a piezoelectric oscillator (also referred to as a piezoelectric actuator). Such piezoelectric oscillators generate a small perturbation on the sheath flow to induce jet flow instability and form droplets. FIG. 1 depicts conventional cell sorter having a piezoelectric oscillator. As shown in FIG. 1, a liquid sample enters at terminal 101. Piezoelectric oscillator 102 generates flow perturbation to create droplets and stream-charging wire 103 applies a charge. The sample is irradiated with light at interrogation zone 104 where scattered and fluorescent light is produced and collected for analysis. Droplets subsequently break off at the distal end of nozzle 106, and deflection plates 107 attract or repel the droplets. Uncharged droplets pass through to waste 108, while charged droplets are received in collection vessels 109. Such conventional droplet formation methods use various nozzle sizes to generate a range of droplet sizes. High pressure in the fluidic system puts stringent requirements on building materials and fluidic sealing.

### SUMMARY

The present inventors have realized that conventional cell sorting systems having piezoelectric oscillators such as those depicted in FIG. 1 produce fluidic perturbation upstream of the interrogation zone, thereby reducing the quality of data obtained therefrom. In addition, such systems require nozzles of different diameters in order to generate droplets of different sizes. As such, it was determined that a single nozzle for generating different-sized droplets that does not generate upstream fluidic perturbation is desirable. Embodiments of the invention satisfy this desire.

Aspects of the invention include nozzles having an elongate body and a gas inlet radially positioned at the proximal end of the elongate body. Elongate bodies of interest include an opening at a proximal end configured to engage in a liquid-receiving relationship with a flow cell, an opening at a distal end for emitting liquid droplets, and a channel configured to transport liquid through the elongate body from the proximal to the distal end. The subject gas inlet comprises a radial airflow path configured to provide a gas to the channel. In some instances, the radial airflow path comprises a height ranging from 150 μm to 250 μm (e.g., 200 μm). In certain cases, the radial airflow path comprises a radius ranging from 200 μm to 300 μm (e.g., 250 μm). The gas inlet may, in some embodiments, include a plurality of radial airflow paths, such as where the number of radial airflow paths in the plurality of radial airflow paths ranges from 2 to 5 (e.g., 4). In some versions, the gas inlet is configured to operably connect to one or more gas conduits. The channel may, in select versions, have a diameter ranging from 150 μm to 250 μm (e.g., 200 μm) and may or may not have a constant diameter throughout the length of the elongate body. In certain instances, the elongate body is cylindrical in shape, and has a length ranging from 4 mm to 4.5 mm (e.g., 4.3 mm).

Aspects of the invention additionally include particle sorters having the subject nozzle. Particle sorters of interest include a flow cell configured to transport particles in a flow stream, as well as a nozzle comprising an elongate body and a gas inlet radially positioned at the proximal end of the elongate body (e.g., as described above). Particle sorters of the invention may, in embodiments, include a source of compressed gas, such as an air compressor or gas canister. In some instances, the source of compressed gas is configured to produce a gas having a pressure ranging from 2 kPa to 10 kPa. In certain versions, particle sorters include one or more gas conduits configured to operably connect the source of compressed gas to the gas inlet. Embodiments of the invention additionally include a processor operably connected to the source of compressed gas and configured to adjust the pressure of the produced gas provided to the gas inlet. In some cases, the nozzle is not operably attached to a piezoelectric actuator. Particle sorters according to some versions also include one or more of: a light source configured to irradiate the flow stream at an interrogation point, a detector configured to collect particle-modulated light from the flow cell, a plurality of receptacles configured to receive the droplets emitted by the opening at the distal end of the elongate structure, and deflection plates configured to deflect the droplets into a given receptacle in the plurality of receptacles.

Aspects of the invention also include methods of sorting a particulate sample. Methods of interest include introducing the particulate sample into a cell sorter comprising a flow cell configured to transport particles in a flow stream, and the subject nozzle (e.g., as described above), and flow cytometrically sorting the particulate sample. In some embodiments, methods include adjusting the pressure of the gas provided to the gas inlet by the source of compressed gas. The particulate sample sorted may, in some cases, be a biological sample, such as cells.

Elements of the disclosure additionally include methods of assembling a particle sorter. Methods of interest include operably connecting a nozzle—such as the nozzle described above—to a flow cell configured to transport particles in a flow stream. In the subject methods, operably connecting the nozzle comprises engaging the opening at the proximal end of the elongate body with the flow cell in a liquid-receiving relationship. In some instances, methods include gaseously connecting a source of compressed gas (e.g., an air compressor) to the gas inlet. In certain instances, methods include operably connecting one or more gas conduits to the source of compressed gas and the gas inlet. In select cases, methods include connecting a processor to the source of compressed gas, wherein the processor is configured to adjust the pressure of the produced gas provided to the gas inlet. Methods according to certain embodiments do not include operably attaching a piezoelectric actuator to the nozzle.

Aspects of the invention further include kits. Kits of interest include the subject nozzle (e.g., as described above). In some cases, kits also include a source of compressed gas (e.g., an air compressor). Kits according to some embodiments of the invention include one or more gas conduits configured to operably connect the source of compressed gas to the gas inlet.

### BRIEF DESCRIPTION OF THE FIGURES

The invention may be best understood from the following detailed description when read in conjunction with the accompanying drawings. Included in the drawings are the following figures:

FIG. 1 depicts a conventional cell sorter having a piezoelectric oscillator.

FIG. 2A-B depicts a nozzle (FIG. 2A) and a conduit (FIG. 2B) according to certain embodiments.

FIG. 3 depicts a particle sorter having a nozzle according to certain embodiments.

FIG. 4 depicts a functional block diagram of a flow cytometric system according to certain embodiments.

FIG. 5 depicts a sorting control system according to certain embodiments.

FIG. 6A-B depicts a schematic drawing of a particle sorter system according to certain embodiments.

FIG. 7 depicts a block diagram of a computing system according to certain embodiments

FIG. 8 depicts a schematic diagram of a nozzle according to certain embodiments.

FIG. 9 depicts the results of a fluidic simulation carried out with respect to a nozzle according to certain embodiments of the invention.

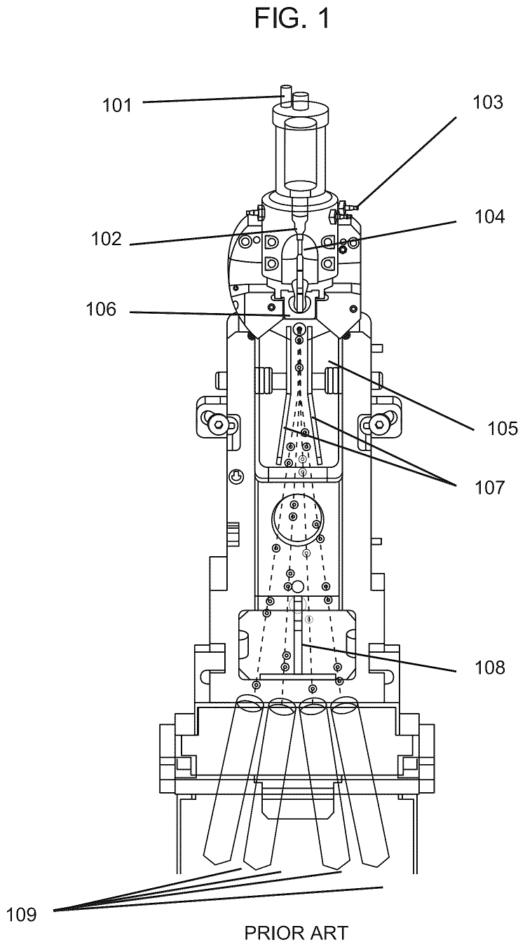

### DETAILED DESCRIPTION

Particle sorter nozzles are provided. Nozzles of interest include an elongate body, and a gas inlet radially positioned at the proximal end of the elongate body. Gas inlets of the subject nozzles include a radial airflow path configured to provide a gas to the channel. The elongate body includes an opening at a proximal end configured to engage in a liquid-receiving relationship with a flow cell, an opening at a distal end for emitting liquid droplets, and a channel configured to transport liquid through the elongate body from the proximal to the distal end. Also provided are particle sorters having the subject nozzles, methods of using and assembling the subject particle sorters, and kits.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the system and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Particle Sorter Nozzles

As discussed above, aspects of the invention include particle sorter nozzles. Nozzles of interest include an elongate body and a gas inlet radially positioned at the proximal end of the elongate body. In some cases, the nozzles described herein permit the creation of liquid droplets having any convenient diameter. In these cases, the creation of liquid droplets having different diameters may be achieved without adjusting the nozzle itself (e.g., by swapping the nozzle with another nozzle having a different diameter). For example, in some cases, liquid droplets produced by the subject nozzles may have any convenient diameter ranging from 75 μm to 230 μm, as desired. The liquid droplets may have any convenient volume ranging from, e.g., 0.25 nL to 6 nL, as desired. In addition, the subject nozzles may reduce fluidic perturbation upstream of the interrogation zone, e.g., by 50% or more, by 55% or more, by 60% or more, by 65% or more, by 70% or more, by 75% or more, by 80% or more, by 85% or more, by 95% or more, by 99% or more and including by 100%.

In addition to the above, the subject nozzles may be employed to generate liquid droplets without the use of a piezoelectric oscillator. The nozzles described herein may instead be used to generate droplets by employing two immiscible fluids: a dispersed phase and a continuous phase. The dispersed phase is a fluid (e.g., a flow stream containing particles) that is to be broken up into droplets. The continuous phase (e.g., air) is immiscible with the dispersed phase and is driven independently. Without being bound by theory, it has been found that when the dispersed phase and continuous phase meet at a junction, the interaction of the two phases at said junction leads to droplet formation. Additional information regarding physical mechanisms employing continuous and dispersed phases can be found in Baroud et al. Lab Chip (2010) 10, 2032-2045; the disclosure of which is herein incorporated by reference.

By “elongate body” it is meant that the subject nozzle possesses a greater length than width. In other words, the nozzle has a distinct proximal and distal end. The proximal end is the end at which, when the nozzle is employed in a particle sorter, the nozzle receives liquid from the flow cell. The distal end is the end at which, when the nozzle is employed in a particle sorter, liquid breaks off and forms droplets. The elongate body may have any convenient cross-sectional shape, where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In embodiments, the elongate body possesses a substantially circular cross-sectional shape at locations along the length. By “substantially” circular cross-section, it is meant that, in embodiments, one or more locations along the length of the nozzle may have a cross-section that slightly deviates from a circular cross-section that characterizes the remainder of the structure. For example, in some versions, the elongate structure has a polygonal (e.g., hexagonal, pentagonal, etc.) cross-section at one or more locations along the length. Put another way, in such versions, the elongate body is not a perfect cylinder and instead possesses some regions having a circular cross-sectional shape with a diameter that is larger than those of other regions. In other cases, the elongate body is cylindrical in shape, e.g., throughout its length. The elongate body may have any convenient length, such as where the length ranges from 3 mm to 5 mm, such as 3.5 mm to 4.75 mm, such as 4 mm to 4.5 mm, and including 4.2 mm to 4.4 mm. In certain cases, the length of the elongate body is 4.3 mm.

Nozzles of interest include an opening at a proximal end configured to engage in a liquid-receiving relationship with a flow cell. In embodiments, the opening is located at the geometric center of the cross-section of the nozzle at the proximal end. By “liquid-receiving” relationship, is meant that the subject nozzles are configured to interface with the flow cell such that liquid being transported through the flow cell (e.g., for analysis) may be received into the nozzle at the proximal end of the elongate body. The proximal end of the elongate body may be configured to interface with the flow cell in any convenient manner. For example, in certain cases, the proximal end of the elongate body interfaces with the flow cell in a liquid- and/or air-tight manner. In such cases, fluid and/or air does not enter or exit the flow cell or nozzle at the interface between the two components. The proximal end may, in certain cases, include a gasket or O-ring for maintaining the liquid- and/or air-tight seal. In other cases, the proximal end includes a groove for receiving an O-ring. The nozzle may include any convenient means for operable attachment to the flow cell including, but not limited to, clamps, magnets, latches, notches, countersinks, counter-bores, grooves, pins, tethers, hinges, non-permanent adhesives or a combination thereof.

The opening at the proximal end may have any convenient cross-sectional shape, where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain cases, the opening has a circular cross-sectional shape. In such cases, the opening may have any suitable diameter, such as where the diameter ranges from 100 μm to 300 μm, such as 125 μm to 275 μm, such as 150 μm to 250 μm, such as 175 μm to 225 μm. such as 190 μm to 210 μm, such as 195 μm to 205 μm and including 199 μm to 201 μm. In certain embodiments, the opening has a diameter of 200 μm.

Nozzles of interest also include an opening at the distal end for emitting liquid droplets. The opening at the distal end may have any convenient cross-sectional shape, where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain cases, the opening has a circular cross-sectional shape. In such cases, the distal end opening may have any suitable diameter, such as where the diameter ranges from 100 μm to 300 μm, such as 125 μm to 275 μm, such as 150 μm to 250 μm, such as 175 μm to 225 μm. such as 190 μm to 210 μm, such as 195 μm to 205 μm and including 199 μm to 201 μm. In certain embodiments, the opening has a diameter of 200 μm.

The subject nozzle also includes a channel in the elongate body running from the proximal end to the distal end and is configured to transport liquid therethrough. The channel may have any convenient cross-sectional shape, where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain cases, the channel has a circular cross-sectional shape. In such cases, the channel may be cylindrical in shape. The channel may have any convenient diameter, such as where the diameter ranges from 100 μm to 300 μm, such as 125 μm to 275 μm, such as 150 μm to 250 μm, such as 175 μm to 225 μm. such as 190 μm to 210 μm, such as 195 μm to 205 μm and including 199 μm to 201 μm. In certain embodiments, the channel has a diameter of 200 μm. The channel may have a constant or variable diameter throughout its length. In some cases, the channel comprises a constant diameter throughout the length of the elongate body. In some such cases, the opening at the proximal end, the opening at the distal end and the entire length of the channel possess the same diameter.

Nozzles of interest include a gas inlet radially positioned at the proximal end of the elongate body. By “gas inlet” it is meant a portal comprising one or more paths through which gas from external source may be transported to the interior of the nozzle. The gas inlet includes a radial airflow path configured to provide a gas to the channel. By “radial airflow path”, it is meant a pathway disposed within the gas inlet through which gas travels to the channel. The gas inlet and its constituent radial airflow paths run in a radial direction with respect to an imaginary axis running through the length of the elongate body. The gas inlet includes any suitable number of radial airflow paths. In certain embodiments, the gas inlet includes a single radial airflow path. In other embodiments, the gas inlet includes a plurality of radial airflow paths. In such embodiments, the number of radial airflow paths may range from 2 to 6, including from 2 to 5. In certain cases, the gas inlet comprises 4 radial airflow paths. The radial airflow paths may have any convenient shape. In some instances, each radial airflow path is wedge-shaped. In such cases, the opening of the radial airflow path that faces the external environment is wide, while the opening of the radial airflow path that faces the channel is comparatively narrow. Each radial airflow path may have any convenient length. The length of each radial airflow path may be conceptualized as a radius measured from the imaginary axis running through the length of the elongate body to the external environment (i.e., the end of the path). For example, the radial airflow path may have a radius ranging from 150 μm to 350 μm, such as 175 μm to 325 μm, such as 200 μm to 300 μm, such as 225 μm to 275 μm, such as 245 μm to 255 μm, and including 249 μm to 251 μm. In certain instances, the radial airflow path comprises a radius of 250 μm. Each radial airflow path may have any convenient height, i.e., as measured from a top surface of the radial airflow path to a bottom surface of the radial airflow path, where the top surface is part of a plane that is closer to the proximal end of the elongate body and the bottom surface is part of a plane that is closer to the distal end of the elongate body. In some cases, the height of the radial airflow path ranges from 100 μm to 300 μm, such as 125 μm to 275 μm, such as 150 μm to 250 μm, such as 175 μm to 225 μm, such as 190 μm to 210 μm, such as 195 μm to 205 μm, and including 199 to 201 μm. In select instances, the radial airflow path comprises a height of 200 μm.

In some embodiments, the gas inlet is configured to operably connect to one or more gas conduits. By “gas conduit” it is meant a channel through which gas may be provided to the gas inlet or a constituent radial airflow path. The radial airflow path(s) may be configured to interface with the gas conduit(s). For example, each radial airflow path may have a shape that is complementary to the shape of the gas conduit, e.g., such that the gas conduit may be releasably attached to the radial airflow path. In some embodiments, the gas conduit is gaseously connected to the radial airflow path via a press fit. In other cases, the gas conduit may be attached to a radial airflow path via clamps, magnets, latches, notches, countersinks, counter-bores, grooves, pins, tethers, hinges, non-permanent adhesives or a combination thereof.

The subject nozzles may be comprised of any convenient material. In certain instances, nozzles include one or more polymeric materials. For example, in some embodiments, nozzles include one or more rigid plastic materials such as, for example, polycarbonates, polyvinyl chloride (PVC), polyurethanes, polyethers, polyamides, polyimides, among other polymeric plastic materials. Examples of polymeric materials include acrylonitrile butadiene styrene (ABS), polylactic acid (PLA), acrylic styrene acrylonitrile (ASA), polyethylene terephthalate (PET), glycol-modified polyethylene terephthalate (PETG), polyaryletherketones (PAEK), polyetherimides (PEI), polypolycarbonate (PC), polypropylene, (PP), aliphatic polyamides (PPA), polyoxymethylene (POM), polymethyl methacrylate (PMMA), polybutylene terephthalate (PBT), polyphenylsulfone (PPSU), polyether ether ketone (PEEK), and nylon as well as composites and hybrids thereof. In certain cases, the nozzle is composed of PEEK. In some embodiments, the nozzle includes a glass-filled polymer (i.e. having glass fibers in a matrix of polymeric material). In such embodiments, any suitable polymer (e.g., such as those described above) may be combined with glass fibers to generate a glass filled polymer. In certain instances, nozzles include one or more metal components including, for example, aluminum, titanium, brass, iron, lead, nickel, steel (e.g., stainless steel), copper, tin as well as combinations and alloys thereof.

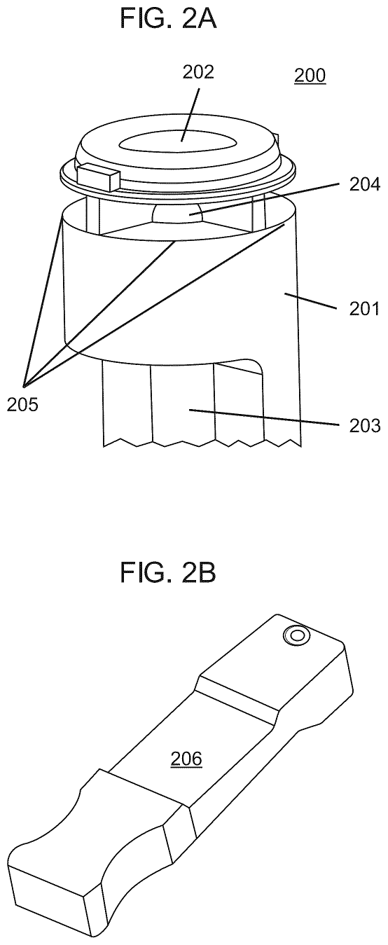

FIG. 2A depicts a nozzle according to certain embodiments of the invention. Nozzle 200 includes an elongate body 201 (only a partial view is shown) having an opening 202 at a proximal end. In the example of FIG. 2A, a part of the elongate body 201 is not present so that channel 203 is visible. Nozzle 200 also includes gas inlet 204 which includes wedge-shaped radial airflow paths 205. The radial airflow paths 205 are configured to receive gas conduit 206 shown in FIG. 2B for providing gas to channel 203.

### Particle Sorters

Aspects of the invention additionally include particle sorters. Particle sorters of interest include a nozzle having an elongate body and a gas inlet (e.g., as described above). A “particle sorter” is any device configured to flow cytometrically sort particles (e.g., beads, cells, etc.). The subject particle sorters may or may not include a piezoelectric actuator. In embodiments, the nozzle is not operably attached to a piezoelectric actuator. By “not operably attached” it is meant that no piezoelectric actuator is present in the vicinity of the flow cell or nozzle such that, when operating, would result in fluidic perturbation sufficient to cause the break-off of droplets. In embodiments where a piezoelectric actuator is not present, droplets are formed by combining a dispersed phase comprising sheath fluid (optionally containing particles) received from the flow cell with a continuous phase comprising a gas. The continuous phase (e.g., air) is immiscible with the dispersed phase and the interaction of the two phases at the gas inlet of the nozzle is sufficient to generate droplets at the distal end of the nozzle. In addition, versions of the subject particle sorters are configured to adjust the size/volume of the generated droplets by varying the amount of pressure applied to the nozzle at the gas inlet. In select cases, the size/volume of the generated droplets is adjusted without changing nozzles or otherwise changing the diameter of the nozzle.

In addition to the nozzle described above, the subject particle sorters include a flow cell having a flow channel for transporting particles in a flow stream therethrough from an inlet at a proximal end to an outlet at a distal end. As discussed herein, the “flow cell” is described in its conventional sense to refer to a component containing a flow channel having a liquid flow stream for transporting particles in a sheath fluid. In embodiments, the subject flow cell includes a cuvette. Cuvettes of interest include containers having a passage running therethrough. The flow stream may include a liquid sample injected from a sample tube. Flow cells of interest include a light-accessible flow channel. In some instances, the flow cell includes transparent material (e.g., quartz) that permits the passage of light therethrough. Any convenient flow cell which propagates a fluidic sample to a sample interrogation region may be employed as the flow cell described herein, where in some embodiments, the flow cell includes is a cylindrical flow cell, a frustoconical flow cell or a flow cell that includes a proximal cylindrical portion defining a longitudinal axis and a distal frustoconical portion which terminates in a flat surface having the orifice that is transverse to the longitudinal axis.

In certain embodiments, the particle sorter includes a sample fluid source. The sample fluid source may be any suitable reservoir or container (e.g., having rigid or flexible walls) for holding a sample fluid. The sample fluid container may have a volume ranging from 1 mL to 100 mL; for example, the volume of the container may range from 1 mL to 90 mL, from 1 mL to 80 mL, from 1 mL to 70 mL, from 1 mL to 60 mL, from 1 mL to 50 mL, from 1 mL to 40 mL, from 1 mL to 30 mL, from 1 mL to 20 mL, or from 1 mL to 10 mL.

In some embodiments, the particle sorter includes a sheath fluid source. The sheath fluid source many be any suitable reservoir or container (e.g., having rigid or flexible walls) for holding sheath fluid. In certain embodiments, the sheath fluid source is fluidically coupled to the input of the flow cell. The sheath fluid container may have a volume ranging from 1 L to 100 L; for example, the volume of the container may range from 1 L to 90 L, from 1 L to 80 L, from 1 L to 70 L, from 1 L to 60 L, from 1 L to 50 L, from 1 L to 40 L, from 1 L to 30 L, from 1 L to 20 L, or from 1 L to 10 L.

In some embodiments, the flow cell includes a sample injection port configured to provide a sample from the sample fluid source to the flow cell. The sample injection port may be an orifice positioned in a wall of the inner chamber or may be a conduit positioned at the proximal end of the inner chamber. Where the sample injection port is an orifice positioned in a wall of the inner chamber, the sample injection port orifice may be any suitable shape where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, etc., as well as irregular shapes, e.g., a parabolic bottom portion coupled to a planar top portion. In certain embodiments, the sample injection port has a circular orifice. The size of the sample injection port orifice may vary depending on shape, in certain instances, having an opening ranging from 0.1 mm to 5.0 mm, such as 0.2 to 3.0 mm, such as 0.5 mm to 2.5 mm, such as from 0.75 mm to 2.25 mm, such as from 1 mm to 2 mm and including from 1.25 mm to 1.75 mm, for example 1.5 mm.

In certain instances, the sample injection port is a conduit positioned at a proximal end of the flow cell inner chamber. For example, the sample injection port may be a conduit positioned to have the orifice of the sample injection port in line with the flow cell orifice. Where the sample injection port is a conduit positioned in line with the flow cell orifice, the cross-sectional shape of the sample injection tube may be any suitable shape where cross-sectional shapes of interest include, but are not limited to: rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The orifice of the conduit may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm. The shape of the tip of the sample injection port may be the same or different from the cross-sectional shape of the sample injection tube. For example, the orifice of the sample injection port may include a beveled tip having a bevel angle ranging from 1 degree to 10 degrees, such as from 2 degrees to 9 degrees, such as from 3 degrees to 8 degrees, such as from 4 degrees to 7 degrees and including a bevel angle of 5 degrees.

In some embodiments, the flow cell also includes a sheath fluid injection port configured to provide a sheath fluid from the sheath fluid source to the flow cell. In embodiments, the sheath fluid injection system is configured to provide a flow of sheath fluid to the flow cell inner chamber, for example in conjunction with the sample to produce a laminated flow stream of sheath fluid surrounding the sample flow stream. Depending on the desired characteristics of the flow stream, the rate of sheath fluid conveyed to the flow cell chamber may be 25 μL/sec to 2500 μL/sec, such as 50 μL/sec to 1000 μL/sec, and including 75 μL/sec or more to 750 μL/sec.

In some embodiments, the sheath fluid injection port is an orifice positioned in a wall of the inner chamber. The sheath fluid injection port orifice may be any suitable shape where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In some embodiments, systems further include a pump in fluid communication with the flow cell to propagate the flow stream through the flow cell. Any convenient fluid pump protocol may be employed to control the flow of the flow stream through the flow cell. In certain instances, systems include a peristaltic pump, such as a peristaltic pump having a pulse damper. The pump in the subject systems is configured to convey fluid through the flow cell at a rate suitable for multi-photon counting of light from the sample in the flow stream. For example, the system may include a pump that is configured to flow sample through the flow cell at a rate that ranges from 1 nL/min to 500 nL/min, such as from 1 nL/min to 250 nL/min, such as from 1 nL/min to 100 nL/min, such as from 2 nL/min to 90 nL/min, such as from 3 nL/min to 80 nL/min, such as from 4 nL/min to 70 nL/min, such as from 5 nL/min to 60 nL/min and including from 10 nL/min to 50 nL/min. In certain embodiments, the flow rate of the flow stream is from 5 nL/min to 6 nL/min.

The flow stream in the flow cell is configured for irradiation with light from a light source at an interrogation point. The flow stream may include a liquid sample injected from a sample tube. In certain embodiments, the flow stream may include a narrow, rapidly flowing stream of liquid that is arranged such that linearly segregated particles transported therein are separated from each other in a single-file manner. The “interrogation point” discussed herein refers to a region within the flow cell in which the particle is irradiated by light from the light source, e.g., for analysis. The size of the interrogation point may vary as desired. For example, where 0 μm represents the axis of light emitted by the light source, the interrogation point may range from −100 μm to 100 μm, such as −50 μm to 50 μm, such as −25 μm to 40 μm, and including −15 μm to 30 μm.

The distal end of the flow cell is operably connected to the proximal end of the nozzle such that the nozzle is in a liquid-receiving relationship with the flow cell. The proximal end of the elongate body may interface with the flow cell in any convenient manner. For example, in certain cases, the proximal end of the elongate body interfaces with the flow cell in a liquid- and/or air-tight manner. In such cases, fluid and/or air does not enter or exit the flow cell or nozzle at the interface between the two components. The proximal end may, in certain cases, include a gasket or O-ring for maintaining the liquid- and/or air-tight seal. In other cases, the proximal end includes a groove for receiving an O-ring. The nozzle may include any convenient means for operable attachment to the flow cell including, but not limited to, clamps, magnets, latches, notches, countersinks, counter-bores, grooves, pins, tethers, hinges, non-permanent adhesives or a combination thereof.

In certain cases, particle sorters include a source of compressed gas. The source of compressed gas may be any device that produces and/or stores gas under pressure. In some embodiments, the source of compressed gas is a gas compressor. In other cases, the source of compressed gas may be a gas canister in which gas is stored under pressure. Any convenient gas may be employed. Gasses of interest include, but are not limited to, O₂, CO₂, N₂, and the like, and combinations thereof. In certain cases, the gas is ambient air from the surrounding environment. In such cases, the gas may be purified to remove any particulates that could potentially contaminate the sample being sorted. For example, the source of compressed gas may be gaseously connected to a compressed air filter configured for particulate removal. In some embodiments, filters of interest may be configured to filter particulates having a size ranging from 1 micron to 100 microns. In some cases where the source of compressed gas is a gas canister, the gas stored in the canister may be purified. The source of compressed gas may be configured to provide a gas to the nozzle having any convenient pressure. For example, in select versions, source of compressed gas is configured to produce a gas having a pressure ranging from 2 kPa to 10 kPa. The source of compressed gas may be adjustable such that the pressure of the gas received at the gas inlet may vary as desired (e.g., to generate droplets having different sizes). In some cases where the source of compressed gas is a gas canister, pressure may be adjusted, e.g., by a pressure regulator. In cases where the source of compressed gas is a gas compressor, the activity of the compressor may be adjusted to regulate the pressure of the gas produced therefrom.

In some embodiments, particle sorters include one or more gas conduits. As described above, gas conduits are channels through which gas may be provided to the gas inlet or a constituent radial airflow path of the subject nozzle. In some cases, the gas conduits are configured to operably connect the source of compressed gas to the gas inlet. Any convenient number of gas conduits may be employed. In some cases, particle sorters include a single gas conduit that gaseously connects the source of compressed gas to a single radial airflow path in the gas inlet. In other instances, particle sorters include a plurality of gas conduits. In some such instances, the number of gas conduits in the plurality of gas conduits ranges from 2 to 6, including 2 to 5. In certain cases, the particle sorter includes 4 gas conduits. The gas conduits may have any convenient cross-sectional shape, where cross-sectional shapes of interest include, but are not limited to rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In some embodiments, gas conduits have a rectangular cross-sectional shape.

The gas conduits may be made of any convenient material. In certain instances, gas conduits include one or more polymeric materials. For example, in some embodiments, gas conduits include one or more rigid plastic materials such as, for example, polycarbonates, polyvinyl chloride (PVC), polyurethanes, polyethers, polyamides, polyimides, among other polymeric plastic materials. Examples of polymeric materials include acrylonitrile butadiene styrene (ABS), polylactic acid (PLA), acrylic styrene acrylonitrile (ASA), polyethylene terephthalate (PET), glycol-modified polyethylene terephthalate (PETG), polyaryletherketones (PAEK), polyetherimides (PEI), polypolycarbonate (PC), polypropylene, (PP), aliphatic polyamides (PPA), polyoxymethylene (POM), polymethyl methacrylate (PMMA), polybutylene terephthalate (PBT), polyphenylsulfone (PPSU), polyether ether ketone (PEEK), and nylon as well as composites and hybrids thereof. In certain cases, the gas conduit is composed of PEEK. In some embodiments, the gas conduit includes a glass-filled polymer (i.e. having glass fibers in a matrix of polymeric material). In such embodiments, any suitable polymer (e.g., such as those described above) may be combined with glass fibers to generate a glass filled polymer. In certain instances, gas conduits include one or more metal components including, for example, aluminum, titanium, brass, iron, lead, nickel, steel (e.g., stainless steel), copper, tin as well as combinations and alloys thereof.

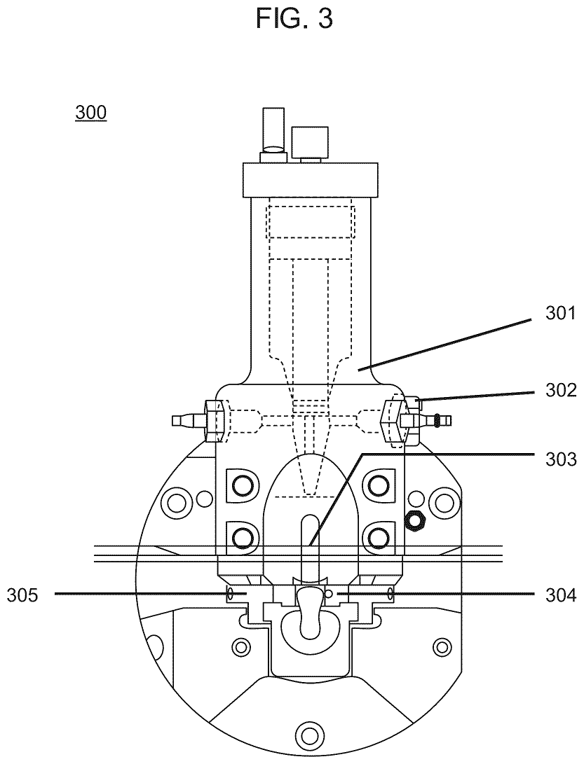

FIG. 3 depicts one view of a particle sorter 300 according to certain embodiments of the invention. As shown in FIG. 3, particle sorter 300 includes a flow cell 301. In addition, titanium hose barbs 302 are provided through which fluid may be provided to the flow cell, e.g., to generate laminar flow. Particles traveling through flow cell 301 are irradiated by laser beams at irradiation point 303. The distal end of flow cell 301 is operably connected to the proximal end of nozzle 304. Particle sorter 300 additionally includes gas conduits 305 through which a compressed gas is provided to the channel of nozzle 304. The provision of gas to the channel via a gas inlet at the proximal end of the nozzle is sufficient to precipitate the generation of droplets at the distal end of the nozzle.

In embodiments, particle sorters additionally include a processor operably connected to the source of compressed gas. Processors of interest may be configured to adjust the pressure of the gas provided to the gas inlet. For example, the subject processors may be operated in conjunction with programmable logic that may be implemented in hardware, software, firmware, or any combination thereof in order to adjust the pressure of the gas provided to the gas inlet. For example, where programmable logic is implemented in software, pressure adjustment may be realized at least in part by a computer-readable data storage medium comprising program code including instructions that, when executed, are configured to adjust the pressure of the gas provided to the gas inlet. For example, where the source of compressed gas is a gas canister, the processor may be operably connected to a regulator associated with said gas canister such that a desired level of pressure may be applied to the gas inlet of the nozzle. In versions where the source of compressed gas is a gas compressor, the processor may be operably connected to the gas compressor such that the processor controls the activity of the compressor, and a desired level of pressure is achieved. In some instances, the processor is configured to increase pressure to decrease the size of the droplets, and decrease pressure to increase the size of the droplets.

In embodiments, particle sorters include a droplet deflector that is configured to divert droplets containing analyzed cells from a stream of droplets produced from the flow stream emanating from the flow nozzle to a receiving location. Diversion of a droplet of interest to a receiving location may be achieved by droplet deflector via electrostatic charging of the droplet and deflection of the charged droplet from the flow stream by the application of an electrostatic field. Such electrostatic fields may be created by deflection plates positioned adjacent to the flow stream. As used herein, the terms “deflection” or “deflected” refer to the electrostatic deflection of droplets of interest from an analyzed flow stream of droplets, such that the cells may be identified and tracked in the flow stream and only those droplets of the flow stream that include those cells of interest are diverted and collected by a collection vessel. In some instances, the particle sorter includes deflection plates that are configured to deflect a single droplet into each collection vessel.

Deflection plates in sort blocks of interest may be configured based on the type of cells being sorted, the rate of sorting, the applied voltage to the cells as well as the number of components being sorted in the sample. In embodiments, the length of suitable deflection plates may range from 5 mm to 100 mm, such as from 6 mm to 90 mm, such as from 7 mm to 80 mm, such as from 8 mm to 70 mm, such as from 9 mm to 60 mm and including from 10 mm to 50 mm. The width of the deflection plates may vary, ranging from 1 mm to 25 mm, such as from 2 mm to 20 mm, such as from 3 mm to 15 mm and including from 5 mm to 10 mm. The distance between each deflection plate may vary depending on the applied voltage as well as the size of the particles being sorted in the flow stream. In some embodiments, the distance between each deflection plate may be 1 mm or more, such as 2 mm or more, such as 3 mm or more, such as 4 mm or more, such as 5 mm or more and including 10 mm or more. For example, the distance between each deflection plate may range from 1 mm to 25 mm, such as from 2 mm to 22.5 mm, such as from 3 mm to 20 mm, such as from 4 mm to 17.5 mm and including from 5 mm to 15 mm. The deflection plates may also be oriented at an angle to each other, such as an angle from 15° to 75°, such as from 20° to 70°, such as from 25° to 65° and including at an angle of from 30° to 60°.

The voltage applied to deflection plates to divert charged particles may be 10 mV or more, such as 25 mV or more, such as 50 mV or more, such as 100 mV or more, such as 250 mV or more, such as 500 mV or more, such as 750 mV or more, such as 1000 mV or more, such as 2500 mV or more, such as 5000 mV or more and including 10000 mV or more. In certain embodiments, the applied voltage to the deflection plates ranges from 0.001 V to 6000 V, including 0.001 V to 5000 V, such as from 0.01 V to 4000 V, such as from 0.1 V to 3000 V, such as from 1 V to 2000 V, such as from 5 V to 1500 V, such as from 10 V to 1000 V, such as from 25 V to 750 V and including from 100 V to 500 V.

The deflection plates are configured to divert particles from the flow stream to a receiving location downstream from the deflection plates. In embodiments, the deflection plates may divert each particle by an angle that varies. In some embodiments, the deflection plates are configured to deflect each particle by an angle of 0.5 degrees or more from the longitudinal axis of the flow stream, such as 1 degree or more, such as 1.5 degrees or more, such as 2 degrees or more, such as 2.5 degrees of more, such as 3 degrees or more, such as 5 degrees or more, such as 7.5 degrees or more and including deflecting each particle by an angle of 10 degrees or more from the longitudinal axis of the flow stream. For example, each particle may be diverted from the longitudinal axis of the flow stream by an angle from 0.1 degrees to 30 degrees, such as from 0.5 degrees to 25 degrees, such as from 1 degree to 20 degrees, such as from 2 degrees to 15 degrees and including from 5 degrees to 10 degrees.

Particles in the flow stream may be deflected by any convenient deflection plate protocol, including but not limited to cell sorting deflection plates as described in U.S. Pat. Nos. 3,960,449; 4,347,935; 4,667,830; 5,245,318; 5,464,581; 5,483,469; 5,602,039; 5,643,796; 5,700,692; 6,372,506 and 6,809,804, 7,880,108 the disclosures of which are herein incorporated by reference in their entirety. In certain embodiments, the deflection plates include charged plates for sorting cells in the flow stream as used in flow cytometry systems such as the BD Biosciences FACSCanto™, BD Biosciences FACSVantage™, BD Biosciences FACSort™, BD Biosciences FACSAria™, BD Biosciences FACSCount™, BD Biosciences FACScan™, and BD Biosciences FACSCalibur™ systems, a BD Biosciences Influx™ cell sorter, or the like.

Particle sorters of interest may additionally include a light source configured to irradiate particles passing through the flow cell at an interrogation point. Any convenient light source may be employed as the light source described herein. In some embodiments, the light source is a laser. In embodiments, the laser may be any convenient laser, such as a continuous wave laser. For example, the laser may be a diode laser, such as an ultraviolet diode laser, a visible diode laser and a near-infrared diode laser. In other embodiments, the laser may be a helium-neon (HeNe) laser. In some instances, the laser is a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the subject flow cytometers include a dye laser, such as a stilbene, coumarin or rhodamine laser. In yet other instances, lasers of interest include a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the subject flow cytometers include a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof.

Laser light sources according to certain embodiments may also include one or more optical adjustment components. In certain embodiments, the optical adjustment component is located between the light source and the flow cell, and may include any device that is capable of changing the spatial width of irradiation or some other characteristic of irradiation from the light source, such as for example, irradiation direction, wavelength, beam width, beam intensity and focal spot. Optical adjustment protocols may include any convenient device which adjusts one or more characteristics of the light source, including but not limited to lenses, mirrors, filters, fiber optics, wavelength separators, pinholes, slits, collimating protocols and combinations thereof. In certain embodiments, flow cytometers of interest include one or more focusing lenses. The focusing lens, in one example, may be a de-magnifying lens. In still other embodiments, flow cytometers of interest include fiber optics.

Where the optical adjustment component is configured to move, the optical adjustment component may be configured to be moved continuously or in discrete intervals, such as for example in 0.01 μm or greater increments, such as 0.05 μm or greater, such as 0.1 μm or greater, such as 0.5 μm or greater such as 1 μm or greater, such as 10 μm or greater, such as 100 μm or greater, such as 500 μm or greater, such as 1 mm or greater, such as 5 mm or greater, such as 10 mm or greater and including 25 mm or greater increments.

Any displacement protocol may be employed to move the optical adjustment component structures, such as coupled to a moveable support stage or directly with a motor actuated translation stage, leadscrew translation assembly, geared translation device, such as those employing a stepper motor, servo motor, brushless electric motor, brushed DC motor, micro-step drive motor, high resolution stepper motor, among other types of motors.

The light source may be positioned any suitable distance from the flow cell, such as where the light source and the flow cell are separated by 0.005 mm or more, such as 0.01 mm or more, such as 0.05 mm or more, such as 0.1 mm or more, such as 0.5 mm or more, such as 1 mm or more, such as 5 mm or more, such as 10 mm or more, such as 25 mm or more and including at a distance of 100 mm or more. In addition, the light source may be positioned at any suitable angle relative to the flow cell, such as at an angle ranging from 10 degrees to 90 degrees, such as from 15 degrees to 85 degrees, such as from 20 degrees to 80 degrees, such as from 25 degrees to 75 degrees and including from 30 degrees to 60 degrees, for example at a 90 degree angle.

In some embodiments, light sources of interest include a plurality of lasers configured to provide laser light for discrete irradiation of the flow stream, such as 2 lasers or more, such as 3 lasers or more, such as 4 lasers or more, such as 5 lasers or more, such as 10 lasers or more, and including 15 lasers or more configured to provide laser light for discrete irradiation of the flow stream. Depending on the desired wavelengths of light for irradiating the flow stream, each laser may have a specific wavelength that varies from 200 nm to 1500 nm, such as from 250 nm to 1250 nm, such as from 300 nm to 1000 nm, such as from 350 nm to 900 nm and including from 400 nm to 800 nm. In certain embodiments, lasers of interest may include one or more of a 405 nm laser, a 488 nm laser, a 561 nm laser and a 635 nm laser.

Particle sorters of interest may further include one or more particle-modulated light detectors for detecting particle-modulated light intensity data. In some embodiments, the particle-modulated light detector(s) include one or more forward-scattered light detectors configured to detect forward-scattered light. For example, the subject particle sorters may include 1 forward-scattered light detector or multiple forward-scattered light detectors, such as 2 or more, such as 3 or more, such as 4 or more, and including 5 or more. In certain embodiments, particle sorters include 1 forward-scattered light detector. In other embodiments, particle sorters include 2 forward-scattered light detectors.

Any convenient detector for detecting collected light may be used in the forward-scattered light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from 0.1 cm² to 8 cm², such as from 0.5 cm² to 7 cm² and including from 1 cm² to 5 cm².

In embodiments, the forward-scattered light detector is configured to measure light continuously or in discrete intervals. In some instances, detectors of interest are configured to take measurements of the collected light continuously. In other instances, detectors of interest are configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

In additional embodiments, the one or more particle-modulated light detector(s) may include one or more side-scattered light detectors for detecting side-scatter wavelengths of light (i.e., light refracted and reflected from the surfaces and internal structures of the particle). In some embodiments, particle sorters include a single side-scattered light detector. In other embodiments, particle sorters include multiple side-scattered light detectors, such as 2 or more, such as 3 or more, such as 4 or more, and including 5 or more.

Any convenient detector for detecting collected light may be used in the side-scattered light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from 0.1 cm² to 8 cm², such as from 0.5 cm² to 7 cm² and including from 1 cm² to 5 cm².

In embodiments, the subject particle sorters also include a fluorescent light detector configured to detect one or more fluorescent wavelengths of light. In other embodiments, particle sorters include multiple fluorescent light detectors such as 2 or more, such as 3 or more, such as 4 or more, 5 or more, 10 or more, 15 or more, and including 20 or more.

Any convenient detector for detecting collected light may be used in the fluorescent light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Where the subject particle sorters include multiple fluorescent light detectors, each fluorescent light detector may be the same, or the collection of fluorescent light detectors may be a combination of different types of detectors. For example, where the subject particle sorters include two fluorescent light detectors, in some embodiments the first fluorescent light detector is a CCD-type device and the second fluorescent light detector (or imaging sensor) is a CMOS-type device. In other embodiments, both the first and second fluorescent light detectors are CCD-type devices. In yet other embodiments, both the first and second fluorescent light detectors are CMOS-type devices. In still other embodiments, the first fluorescent light detector is a CCD-type device and the second fluorescent light detector is a photomultiplier tube (PMT). In still other embodiments, the first fluorescent light detector is a CMOS-type device and the second fluorescent light detector is a photomultiplier tube. In yet other embodiments, both the first and second fluorescent light detectors are photomultiplier tubes.

In embodiments of the present disclosure, fluorescent light detectors of interest are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths. In some embodiments, 2 or more detectors in the particle sorters as described herein are configured to measure the same or overlapping wavelengths of collected light.

In some embodiments, fluorescent light detectors of interest are configured to measure collected light over a range of wavelengths (e.g., 200 nm-1000 nm). In certain embodiments, detectors of interest are configured to collect spectra of light over a range of wavelengths. For example, particle sorters may include one or more detectors configured to collect spectra of light over one or more of the wavelength ranges of 200 nm-1000 nm. In yet other embodiments, detectors of interest are configured to measure light emitted by a sample in the flow stream at one or more specific wavelengths. For example, particle sorters may include one or more detectors configured to measure light at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof. In certain embodiments, one or more detectors may be configured to be paired with specific fluorophores, such as those used with the sample in a fluorescence assay.

In some embodiments, particle sorters include one or more wavelength separators positioned between the flow cell and the particle-modulated light detector(s). The term “wavelength separator” is used herein in its conventional sense to refer to an optical component that is configured to separate light collected from the sample into predetermined spectral ranges. In some embodiments, particle sorters include a single wavelength separator. In other embodiments, particle sorters include a plurality of wavelength separators, such as 2 or more wavelength separators, such as 3 or more, such as 4 or more, such as 5 or more, such as 6 or more, such as 7 or more, such as 8 or more, such as 9 or more, such as 10 or more, such as 15 or more, such as 25 or more, such as 50 or more, such as 75 or more and including 100 or more wavelength separators. In some embodiments, the wavelength separator is configured to separate light collected from the sample into predetermined spectral ranges by passing light having a predetermined spectral range and reflecting one or more remaining spectral ranges of light. In other embodiments, the wavelength separator is configured to separate light collected from the sample into predetermined spectral ranges by passing light having a predetermined spectral range and absorbing one or more remaining spectral ranges of light. In yet other embodiments, the wavelength separator is configured to spatially diffract light collected from the sample into predetermined spectral ranges. Each wavelength separator may be any convenient light separation protocol, such as one or more dichroic mirrors, bandpass filters, diffraction gratings, beam splitters or prisms. In some embodiments, the wavelength separator is a prism. In other embodiments, the wavelength separator is a diffraction grating. In certain embodiments, wavelength separators in the subject light detection systems are dichroic mirrors.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter or the like.

In some embodiments, the subject systems are flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

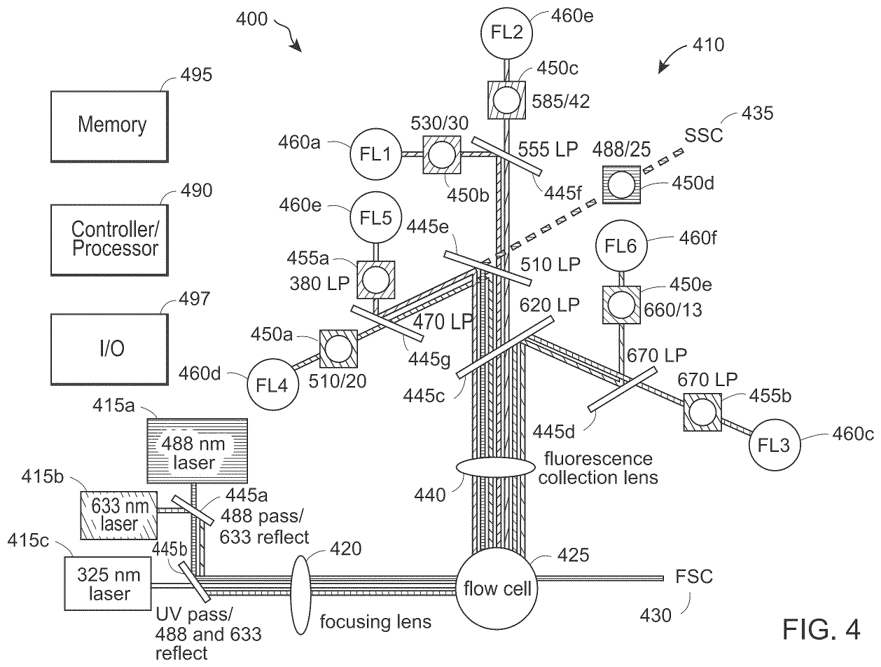

FIG. 4 shows a system 400 for flow cytometry in accordance with an illustrative embodiment of the present invention. The system 400 includes a flow cytometer 410, a controller/processor 490 and a memory 495. The flow cytometer 410 includes one or more excitation lasers 415a-415c, a focusing lens 420, a flow chamber 425, a forward-scatter detector 430, a side-scatter detector 435, a fluorescence collection lens 440, one or more beam splitters 445a-445g, one or more bandpass filters 450a-450e, one or more longpass (“LP”) filters 455a-455b, and one or more fluorescent detectors 460a-460f.

The excitation lasers 415a-c emit light in the form of a laser beam. The wavelengths of the laser beams emitted from excitation lasers 415a-415c are 488 nm, 633 nm, and 325 nm, respectively, in the example system of FIG. 4. The laser beams are first directed through one or more of beam splitters 445a and 445b. Beam splitter 445a transmits light at 488 nm and reflects light at 633 nm. Beam splitter 445b transmits UV light (light with a wavelength in the range of 10 to 400 nm) and reflects light at 488 nm and 633 nm.

The laser beams are then directed to a focusing lens 420, which focuses the beams onto the portion of a fluid stream where particles of a sample are located, within the flow chamber 425. The flow chamber is part of a fluidics system which directs particles, typically one at a time, in a stream to the focused laser beam for interrogation. The flow chamber can comprise a flow cell in a benchtop cytometer or a nozzle tip in a stream-in-air cytometer.

The light from the laser beam(s) interacts with the particles in the sample by diffraction, refraction, reflection, scattering, and absorption with re-emission at various different wavelengths depending on the characteristics of the particle such as its size, internal structure, and the presence of one or more fluorescent molecules attached to or naturally present on or in the particle. The fluorescence emissions as well as the diffracted light, refracted light, reflected light, and scattered light may be routed to one or more of the forward-scatter detector 430, the side-scatter detector 435, and the one or more fluorescent detectors 460a-460f through one or more of the beam splitters 445c-445g, the bandpass filters 450a-450e, the longpass filters 455a-455b, and the fluorescence collection lens 440.

The fluorescence collection lens 440 collects light emitted from the particle-laser beam interaction and routes that light towards one or more beam splitters and filters. Bandpass filters, such as bandpass filters 450a-450e, allow a narrow range of wavelengths to pass through the filter. For example, bandpass filter 450a is a 510/20 filter. The first number represents the center of a spectral band. The second number provides a range of the spectral band. Thus, a 510/20 filter extends 10 nm on each side of the center of the spectral band, or from 500 nm to 520 nm. Shortpass filters transmit wavelengths of light equal to or shorter than a specified wavelength. Longpass filters, such as longpass filters 455a-455b, transmit wavelengths of light equal to or longer than a specified wavelength of light. For example, longpass filter 455b, which is a 670 nm longpass filter, transmits light equal to or longer than 670 nm. Filters are often selected to optimize the specificity of a detector for a particular fluorescent dye. The filters can be configured so that the spectral band of light transmitted to the detector is close to the emission peak of a fluorescent dye.

The forward-scatter detector 430 is positioned slightly off axis from the direct beam through the flow cell and is configured to detect diffracted light, the excitation light that travels through or around the particle in mostly a forward direction. The intensity of the light detected by the forward-scatter detector is dependent on the overall size of the particle. The forward-scatter detector can include a photodiode. The side-scatter detector 435 is configured to detect refracted and reflected light from the surfaces and internal structures of the particle that tends to increase with increasing particle complexity of structure. The fluorescence emissions from fluorescent molecules associated with the particle can be detected by the one or more fluorescent detectors 460a-460f. The side-scatter detector 435 and fluorescent detectors can include photomultiplier tubes. The signals detected at the forward-scatter detector 430, the side-scatter detector 435 and the fluorescent detectors can be converted to electronic signals (voltages) by the detectors. This data can provide information about the sample.

One of skill in the art will recognize that a flow cytometer in accordance with an embodiment of the present invention is not limited to the flow cytometer depicted in FIG. 4, but can include any flow cytometer known in the art. For example, a flow cytometer may have any number of lasers, beam splitters, filters, and detectors at various wavelengths and in various different configurations.

In operation, cytometer operation is controlled by a controller/processor 490, and the measurement data from the detectors can be stored in the memory 495 and processed by the controller/processor 490. Although not shown explicitly, the controller/processor 490 is coupled to the detectors to receive the output signals therefrom, and may also be coupled to electrical and electromechanical components of the flow cytometer 410 to control the lasers, fluid flow parameters, and the like. Input/output (I/O) capabilities 497 may be provided also in the system. The memory 495, controller/processor 490, and I/O 497 may be entirely provided as an integral part of the flow cytometer 410. In such an embodiment, a display may also form part of the I/O capabilities 497 for presenting experimental data to users of the cytometer 410. Alternatively, some or all of the memory 495 and controller/processor 490 and I/O capabilities may be part of one or more external devices such as a general purpose computer. In some embodiments, some or all of the memory 495 and controller/processor 490 can be in wireless or wired communication with the cytometer 410. The controller/processor 490 in conjunction with the memory 495 and the I/O 497 can be configured to perform various functions related to the preparation and analysis of a flow cytometer experiment.

The system illustrated in FIG. 4 includes six different detectors that detect fluorescent light in six different wavelength bands (which may be referred to herein as a “filter window” for a given detector) as defined by the configuration of filters and/or splitters in the beam path from the flow cell 425 to each detector. Different fluorescent molecules in a fluorochrome panel used for a flow cytometer experiment will emit light in their own characteristic wavelength bands. The particular fluorescent labels used for an experiment and their associated fluorescent emission bands may be selected to generally coincide with the filter windows of the detectors. The I/O 497 can be configured to receive data regarding a flow cytometer experiment having a panel of fluorescent labels and a plurality of cell populations having a plurality of markers, each cell population having a subset of the plurality of markers. The I/O 497 can also be configured to receive biological data assigning one or more markers to one or more cell populations, marker density data, emission spectrum data, data assigning labels to one or more markers, and cytometer configuration data. Flow cytometer experiment data, such as label spectral characteristics and flow cytometer configuration data can also be stored in the memory 495. The controller/processor 490 can be configured to evaluate one or more assignments of labels to markers.

In some embodiments, the subject systems are particle sorting systems that are configured to sort particles with an enclosed particle sorting module, such as those described in U.S. Patent Publication No. 2017/0299493, filed on Mar. 28, 2017, the disclosure of which is incorporated herein by reference. In certain embodiments, particles (e.g., cells) of the sample are sorted using a sort decision module having a plurality of sort decision units, such as those described in U.S. Patent Publication No. 2020/0256781, filed on Dec. 23, 2019, the disclosure of which is incorporated herein by reference. In some embodiments, systems for sorting components of a sample include a particle sorting module having deflection plates, such as described in U.S. Patent Publication No. 2017/0299493, filed on Mar. 28, 2017, the disclosure of which is incorporated herein by reference.

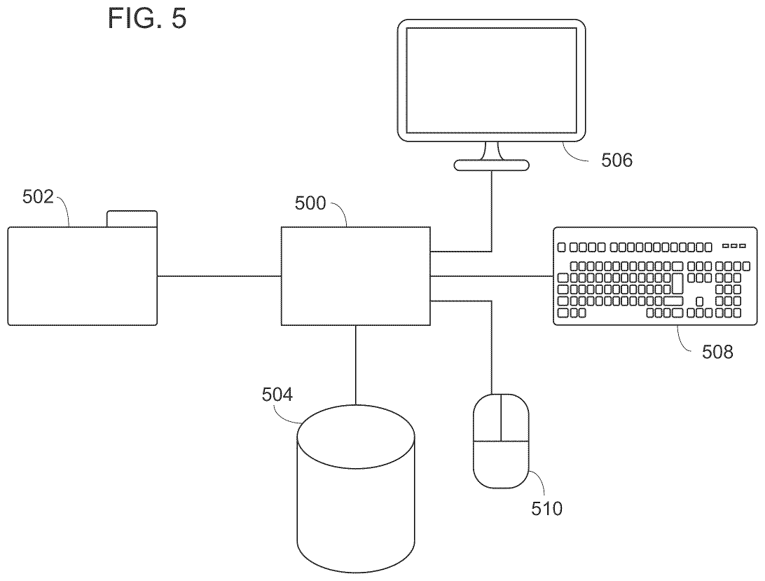

FIG. 5 shows a functional block diagram for one example of a sorting control system, such as a processor 500, for analyzing and displaying biological events. A processor 500 can be configured to implement a variety of processes for controlling graphic display of biological events.

A flow cytometer or sorting system 502 can be configured to acquire biological event data. For example, a flow cytometer can generate flow cytometric event data (e.g., particle-modulated light data). The flow cytometer 502 can be configured to provide biological event data to the processor 500. A data communication channel can be included between the flow cytometer 502 and the processor 500. The biological event data can be provided to the processor 500 via the data communication channel.

The processor 500 can be configured to receive biological event data from the flow cytometer 502. The biological event data received from the flow cytometer 502 can include flow cytometric event data. The processor 500 can be configured to provide a graphical display including a first plot of biological event data to a display device 506. The processor 500 can be further configured to render a region of interest as a gate (e.g., a first gate) around a population of biological event data shown by the display device 506, overlaid upon the first plot, for example. In some embodiments, the gate can be a logical combination of one or more graphical regions of interest drawn upon a single parameter histogram or bivariate plot. In some embodiments, the display can be used to display particle parameters or saturated detector data.

The processor 500 can be further configured to display the biological event data on the display device 506 within the gate differently from other events in the biological event data outside of the gate. For example, the processor 500 can be configured to render the color of biological event data contained within the gate to be distinct from the color of biological event data outside of the gate. The display device 506 can be implemented as a monitor, a tablet computer, a smartphone, or other electronic device configured to present graphical interfaces.

The processor 500 can be configured to receive a gate selection signal identifying the gate from a first input device. For example, the first input device can be implemented as a mouse 510. The mouse 510 can initiate a gate selection signal to the processor 500 identifying the gate to be displayed on or manipulated via the display device 506 (e.g., by clicking on or in the desired gate when the cursor is positioned there). In some implementations, the first device can be implemented as the keyboard 508 or other means for providing an input signal to the processor 500 such as a touchscreen, a stylus, an optical detector, or a voice recognition system. Some input devices can include multiple inputting functions. In such implementations, the inputting functions can each be considered an input device. For example, as shown in FIG. 5, the mouse 510 can include a right mouse button and a left mouse button, each of which can generate a triggering event.

The triggering event can cause the processor 500 to alter the manner in which the data is displayed, which portions of the data is actually displayed on the display device 506, and/or provide input to further processing such as selection of a population of interest for particle sorting.

In some embodiments, the processor 500 can be configured to detect when gate selection is initiated by the mouse 510. The processor 500 can be further configured to automatically modify plot visualization to facilitate the gating process. The modification can be based on the specific distribution of biological event data received by the processor 500. In some embodiments, the processor 500 expands the first gate such that a second gate is generated (e.g., as discussed above).

The processor 500 can be connected to a storage device 504. The storage device 504 can be configured to receive and store biological event data from the processor 500. The storage device 504 can also be configured to receive and store flow cytometric event data from the processor 500. The storage device 504 can be further configured to allow retrieval of biological event data, such as flow cytometric event data, by the processor 500.

The display device 506 can be configured to receive display data from the processor 500. The display data can comprise plots of biological event data and gates outlining sections of the plots. The display device 506 can be further configured to alter the information presented according to input received from the processor 500 in conjunction with input from the flow cytometer 502, the storage device 504, the keyboard 508, and/or the mouse 510.

In some implementations the processor 500 can generate a user interface to receive example events for sorting. For example, the user interface can include a mechanism for receiving example events or example images. The example events or images or an example gate can be provided prior to collection of event data for a sample or based on an initial set of events for a portion of the sample.

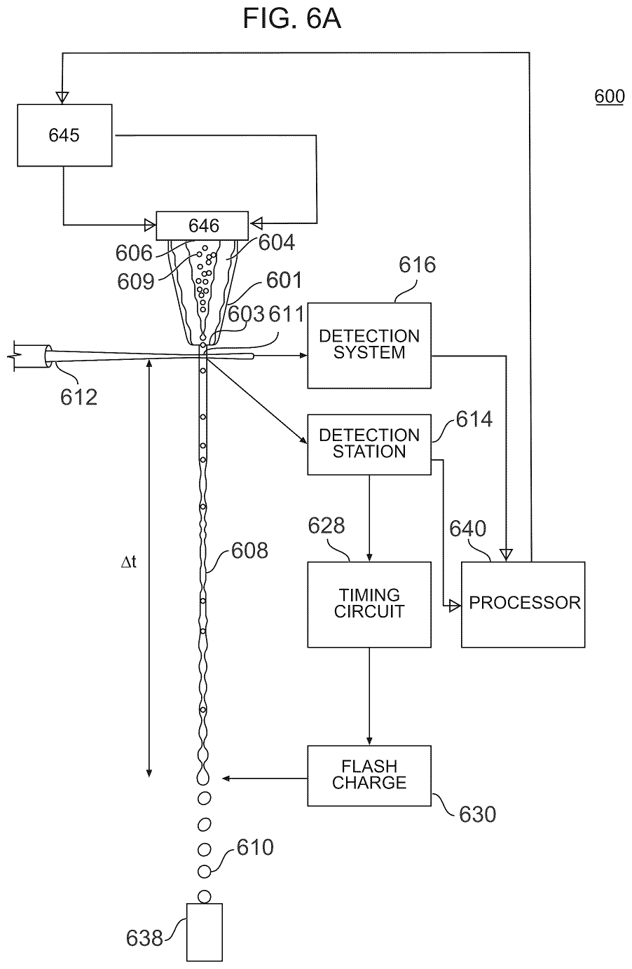

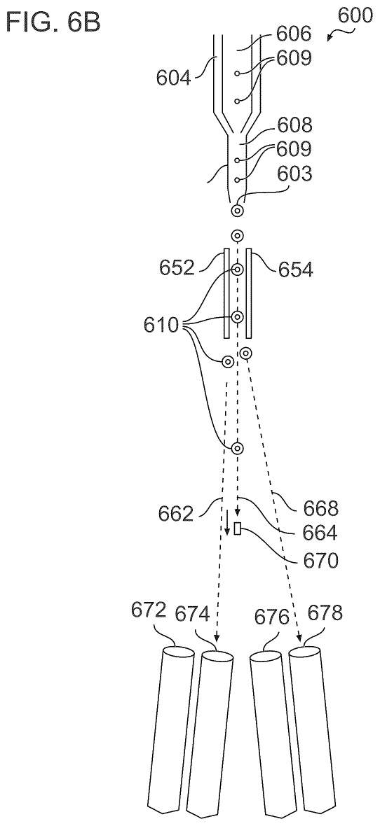

FIG. 6A is a schematic drawing of a particle sorter system 600 (e.g., the flow cytometer 502) in accordance with one embodiment presented herein. In some embodiments, the particle sorter system 600 is a cell sorter system. Nozzle 603 emits liquid in a moving fluid column 608 at the distal end. Within the fluid conduit 601, sheath fluid 604 hydrodynamically focuses a sample fluid 606 comprising particles 609 into the moving fluid column 608 (e.g., a stream). Within the moving fluid column 608, particles 609 (e.g., cells) are lined up in single file to cross a monitored area 611 (e.g., where laser-stream intersect), irradiated by an irradiation source 612 (e.g., a laser). Nozzle 603 comprises gas inlet 646 comprising a plurality of radial airflow paths (not shown). Air from a source of compressed gas 645 is provided to gas inlet 646 via gas conduits. The interaction between the sample fluid 606 and the air causes moving fluid column 608 to break into a plurality of drops 610, some of which contain particles 609.

In operation, a detection station 614 (e.g., an event detector) identifies when a particle of interest (or cell of interest) crosses the monitored area 611. Detection station 614 feeds into a timing circuit 628, which in turn feeds into a flash charge circuit 630. At a drop break off point, informed by a timed drop delay (Δt), a flash charge can be applied to the moving fluid column 608 such that a drop of interest carries a charge. The drop of interest can include one or more particles or cells to be sorted. The charged drop can then be sorted by activating deflection plates (not shown) to deflect the drop into a vessel such as a collection tube or a multi-well or microwell sample plate where a well or microwell can be associated with drops of particular interest. As shown in FIG. 6A, the drops can be collected in a drain receptacle 638. A detection system 616 (e.g., a drop boundary detector) serves to automatically determine the phase of a drop drive signal when a particle of interest passes the monitored area 611. An exemplary drop boundary detector is described in U.S. Pat. No. 7,679,039, which is incorporated herein by reference in its entirety. The detection system 616 allows the instrument to accurately calculate the place of each detected particle in a drop. In the example of FIG. 6A, the detection system 616 is connected to processor 640 and provides information regarding moving fluid column 608 thereto. Processor 640 is operably connected to source of compressed gas 645, and is configured to adjust the pressure of the gas produced by source of compressed gas 645 in response to measurements from the detection system and/or input from a user. In this manner, the size and volume of droplets 610 may be adjusted.

In some implementations, sort electronics (e.g., the detection system 616, the detection station 614 and a processor 640) can be coupled with a memory configured to store the detected events and a sort decision based thereon. The sort decision can be included in the event data for a particle. In some implementations, the detection system 616 and the detection station 614 can be implemented as a single detection unit or communicatively coupled such that an event measurement can be collected by one of the detection system 616 or the detection station 614 and provided to the non-collecting element.

FIG. 6B is a schematic drawing of a particle sorter system, in accordance with one embodiment presented herein. The particle sorter system 600 shown in FIG. 6B, includes deflection plates 652 and 654. A charge can be applied via a stream-charging wire in a barb. This creates a stream of droplets 610 containing particles 609 for analysis. The particles can be illuminated with one or more light sources (e.g., lasers) to generate light scatter and fluorescence information. The information for a particle is analyzed such as by sorting electronics or other detection system (not shown in FIG. 6B). The deflection plates 652 and 654 can be independently controlled to attract or repel the charged droplet to guide the droplet toward a destination collection vessel (e.g., one of 672, 674, 676, or 678). As shown in FIG. 6B, the deflection plates 652 and 654 can be controlled to direct a particle along a first path 662 toward the vessel 674 or along a second path 668 toward the vessel 678. If the particle is not of interest (e.g., does not exhibit scatter or illumination information within a specified sort range), deflection plates may allow the particle to continue along a flow path 664. Such uncharged droplets may pass into a waste receptacle such as via aspirator 670.

The sorting electronics can be included to initiate collection of measurements, receive fluorescence signals for particles, and determine how to adjust the deflection plates to cause sorting of the particles. Example implementations of the embodiment shown in FIG. 6B include the BD FACSAria™ line of flow cytometers commercially provided by Becton, Dickinson and Company (Franklin Lakes, NJ).

### Methods of Sorting a Particulate Sample

As discussed above, aspects of the invention also include methods of sorting a particulate sample. Methods of interest include introducing the particulate sample into a cell sorter comprising a flow cell configured to transport particles in a flow stream and a nozzle, and flow cytometrically sorting the particulate sample. As mentioned above, the subject nozzle includes an elongate body comprising an opening at a proximal end engaged in a liquid-receiving relationship with the flow cell, an opening at a distal end for emitting liquid droplets, and a channel configured to transport liquid through the elongate body from the proximal to the distal end. In addition, nozzles of the invention include a gas inlet radially positioned at the proximal end of the elongate body, wherein the gas inlet comprises a radial airflow path configured to provide a gas to the channel.

In some embodiments, methods include adjusting the pressure of the gas provided to the gas inlet by the source of compressed gas. In such embodiments, a user may input a desired pressure or droplet size/volume, e.g., using user interface devices such as those described above with respect to FIG. 5. The inputted values may be received by the processor, which then adjusts the source of compressed gas accordingly.

In some instances, the sample analyzed in the instant methods is a biological sample. The term “biological sample” is used in its conventional sense to refer to a whole organism, plant, fungi or a subset of animal tissues, cells or component parts which may in certain instances be found in blood, mucus, lymphatic fluid, synovial fluid, cerebrospinal fluid, saliva, bronchoalveolar lavage, amniotic fluid, amniotic cord blood, urine, vaginal fluid and semen. As such, a “biological sample” refers to both the native organism or a subset of its tissues as well as to a homogenate, lysate or extract prepared from the organism or a subset of its tissues, including but not limited to, for example, plasma, serum, spinal fluid, lymph fluid, sections of the skin, respiratory, gastrointestinal, cardiovascular, and genitourinary tracts, tears, saliva, milk, blood cells, tumors, organs. Biological samples may be any type of organismic tissue, including both healthy and diseased tissue (e.g., cancerous, malignant, necrotic, etc.). In certain embodiments, the biological sample is a liquid sample, such as blood or derivative thereof, e.g., plasma, tears, urine, semen, etc., where in some instances the sample is a blood sample, including whole blood, such as blood obtained from venipuncture or fingerstick (where the blood may or may not be combined with any reagents prior to assay, such as preservatives, anticoagulants, etc.).

In certain embodiments the source of the sample is a “mammal” or “mammalian”, where these terms are used broadly to describe organisms which are within the class Mammalia, including the orders carnivore (e.g., dogs and cats), Rodentia (e.g., mice, guinea pigs, and rats), and primates (e.g., humans, chimpanzees, and monkeys). In some instances, the subjects are humans. The methods may be applied to samples obtained from human subjects of both genders and at any stage of development (i.e., neonates, infant, juvenile, adolescent, adult), where in certain embodiments the human subject is a juvenile, adolescent or adult. While the present invention may be applied to samples from a human subject, it is to be understood that the methods may also be carried-out on samples from other animal subjects (that is, in “non-human subjects”) such as, but not limited to, birds, mice, rats, dogs, cats, livestock and horses.

Cells of interest may be targeted for characterized according to a variety of parameters, such as a phenotypic characteristic identified via the attachment of a particular fluorescent label to cells of interest. In some embodiments, the system is configured to deflect analyzed droplets that are determined to include a target cell. A variety of cells may be characterized using the subject methods. Target cells of interest include, but are not limited to, stem cells, T cells, dendritic cells, B Cells, granulocytes, leukemia cells, lymphoma cells, virus cells (e.g., HIV cells), NK cells, macrophages, monocytes, fibroblasts, epithelial cells, endothelial cells, and erythroid cells. Target cells of interest include cells that have a convenient cell surface marker or antigen that may be captured or labelled by a convenient affinity agent or conjugate thereof. For example, the target cell may include a cell surface antigen such as CD11b, CD123, CD14, CD15, CD16, CD19, CD193, CD2, CD25, CD27, CD3, CD335, CD36, CD4, CD43, CD45RO, CD56, CD61, CD7, CD8, CD34, CD1c, CD23, CD304, CD235a, T cell receptor alpha/beta, T cell receptor gamma/delta, CD253, CD95, CD20, CD105, CD117, CD120b, Notch4, Lgr5 (N-Terminal), SSEA-3, TRA-1-60 Antigen, Disialoganglioside GD2 and CD71. In some embodiments, the target cell is selected from HIV containing cell, a Treg cell, an antigen-specific T-cell populations, tumor cells or hematopoietic progenitor cells (CD34+) from whole blood, bone marrow or cord blood.

In practicing the subject methods, an amount of an initial fluidic sample is injected into the flow cytometer. The amount of sample injected into the particle sorting module may vary, for example, ranging from 0.001 mL to 1000 mL, such as from 0.005 mL to 900 mL, such as from 0.01 mL to 800 mL, such as from 0.05 mL to 700 mL, such as from 0.1 mL to 600 mL, such as from 0.5 mL to 500 mL, such as from 1 mL to 400 mL, such as from 2 mL to 300 mL and including from 5 mL to 100 mL of sample.

Methods according to embodiments of the present disclosure include counting and sorting labeled particles (e.g., target cells) in a sample. In practicing the subject methods, the fluidic sample including the particles is first introduced into a flow nozzle of the system. Upon exit from the flow nozzle, the particles are passed substantially one at a time through the sample interrogation region where each of the particles is irradiated to a source of light and measurements of light scatter parameters and, in some instances, fluorescent emissions as desired (e.g., two or more light scatter parameters and measurements of one or more fluorescent emissions) are separately recorded for each particle. Depending on the properties of the flow stream being interrogated, 0.001 mm or more of the flow stream may be irradiated with light, such as 0.005 mm or more, such as 0.01 mm or more, such as 0.05 mm or more, such as 0.1 mm or more, such as 0.5 mm or more and including 1 mm or more of the flow stream may be irradiated with light. In certain embodiments, methods include irradiating a planar cross-section of the flow stream in the sample interrogation region, such as with a laser (as described above). In other embodiments, methods include irradiating a predetermined length of the flow stream in the sample interrogation region, such as corresponding to the irradiation profile of a diffuse laser beam or lamp.

In certain embodiments, methods including irradiating the flow stream at or near the flow cell nozzle orifice. For example, methods may include irradiating the flow stream at a position about 0.001 mm or more from the nozzle orifice, such as 0.005 mm or more, such as 0.01 mm or more, such as 0.05 mm or more, such as 0.1 mm or more, such as 0.5 mm or more and including 1 mm or more from the nozzle orifice. In certain embodiments, methods include irradiating the flow stream immediately adjacent to the flow cell nozzle orifice.

In embodiments of the method, detectors, such as photomultiplier tubes (PMT), are used to record light that passes through each particle (in certain cases referred to as forward light scatter), light that is reflected orthogonal to the direction of the flow of the particles through the sensing region (in some cases referred to as orthogonal or side light scatter) and fluorescent light emitted from the particles, if it is labeled with fluorescent marker(s), as the particle passes through the sensing region and is illuminated by the energy source. Each of forward light scatter (FSC), side-scatter (SSC), and fluorescence emissions include a separate parameter for each particle (or each “event”). Thus, for example, two, three or four parameters can be collected (and recorded) from a particle labeled with two different fluorescence markers.

In some embodiments, methods include detaching the adapter from the sorting flow cytometer. In some instances, methods further include reattaching a second adapter to the particle sorting system after the first particle sorting module has been removed. The first adapter may be washed and sterilized for subsequent use (e.g., with an autoclave) or may be discarded.

The data recorded for each particle is analyzed in real time or stored in a data storage and analysis means, such as a computer, as desired. U.S. Pat. No. 4,284,412 describes the configuration and use of a flow cytometer of interest equipped with a single light source while U.S. Pat. No. 4,727,020 describes the configuration and use of a flow cytometer equipped with two light sources.

In certain embodiments, the particles are detected and uniquely identified by exposing the particles to excitation light and measuring the fluorescence of each particle in one or more detection channels, as desired. Fluorescence emitted in detection channels used to identify the particles and binding complexes associated therewith may be measured following excitation with a single light source, or may be measured separately following excitation with distinct light sources. If separate excitation light sources are used to excite the particle labels, the labels may be selected such that all the labels are excitable by each of the excitation light sources used.

Methods in certain embodiments also include data acquisition, analysis and recording, such as with a computer, wherein multiple data channels record data from each detector for the light scatter and fluorescence emitted by each particle as it passes through the sample interrogation region of the particle sorting module. In these embodiments, analysis includes classifying and counting particles such that each particle is present as a set of digitized parameter values. The subject systems may be set to trigger on a selected parameter in order to distinguish the particles of interest from background and noise. “Trigger” refers to a preset threshold for detection of a parameter and may be used as a means for detecting passage of a particle through the light source. Detection of an event that exceeds the threshold for the selected parameter triggers acquisition of light scatter and fluorescence data for the particle. Data is not acquired for particles or other components in the medium being assayed which cause a response below the threshold. The trigger parameter may be the detection of forward-scattered light caused by passage of a particle through the light beam. The flow cytometer then detects and collects the light scatter and fluorescence data for the particle.

A particular subpopulation of interest is then further analyzed by “gating” based on the data collected for the entire population. To select an appropriate gate, the data is plotted so as to obtain the best separation of subpopulations possible. This procedure may be performed by plotting forward light scatter (FSC) vs. side (i.e., orthogonal) light scatter (SSC) on a two dimensional dot plot. A subpopulation of particles is then selected (i.e., those cells within the gate) and particles that are not within the gate are excluded. Where desired, the gate may be selected by drawing a line around the desired subpopulation using a cursor on a computer screen. Only those particles within the gate are then further analyzed by plotting the other parameters for these particles, such as fluorescence. Where desired, the above analysis may be configured to yield counts of the particles of interest in the sample.

Methods of interest may further include employing sorted particles in research, laboratory testing, or therapy. In some embodiments, the subject methods include obtaining individual cells prepared from a target fluidic or tissue biological sample. For example, the subject methods include obtaining cells from fluidic or tissue samples to be used as a research or diagnostic specimen for diseases such as cancer. Likewise, the subject methods include obtaining cells from fluidic or tissue samples to be used in therapy. A cell therapy protocol is a protocol in which viable cellular material including, e.g., cells and tissues, may be prepared and introduced into a subject as a therapeutic treatment. Conditions that may be treated by the administration of the flow cytometrically sorted sample include, but are not limited to, blood disorders, immune system disorders, organ damage, etc.

A typical cell therapy protocol may include the following steps: sample collection, cell isolation, genetic modification, culture, and expansion in vitro, cell harvesting, sample volume reduction and washing, bio-preservation, storage, and introduction of cells into a subject. The protocol may begin with the collection of viable cells and tissues from source tissues of a subject to produce a sample of cells and/or tissues. The sample may be collected via any suitable procedure that includes, e.g., administering a cell mobilizing agent to a subject, drawing blood from a subject, removing bone marrow from a subject, etc. After collecting the sample, cell enrichment may occur via several methods including, e.g., centrifugation based methods, filter based methods, elutriation, magnetic separation methods, fluorescence-activated cell sorting (FACS), and the like. In some cases, the enriched cells may be genetically modified by any convenient method, e.g., nuclease mediated gene editing. The genetically modified cells can be cultured, activated, and expanded in vitro. In some cases, the cells are preserved, e.g., cryopreserved, and stored for future use where the cells are thawed and then administered to a patient, e.g., the cells may be infused in the patient.

### Methods of Assembling a Particle Sorter

As discussed above, methods of the invention further include methods of assembling a particle sorter. Methods of interest include operably connecting a nozzle to a flow cell configured to transport particles in a flow stream. As mentioned above, the subject nozzle includes an elongate body comprising an opening at a proximal end engaged in a liquid-receiving relationship with the flow cell, an opening at a distal end for emitting liquid droplets, and a channel configured to transport liquid through the elongate body from the proximal to the distal end. In addition, nozzles of the invention include a gas inlet radially positioned at the proximal end of the elongate body, wherein the gas inlet comprises a radial airflow path configured to provide a gas to the channel. By “operably connecting” the nozzle to the flow cell, it is meant engaging the opening at the proximal end of the elongate body with the flow cell in a liquid-receiving relationship. In certain versions, methods include operably connecting the flow cell and nozzle in a fluid-tight manner (e.g., air-tight, liquid tight). In such cases, one or more gaskets and/or O-rings may be employed.

In some cases, methods additionally include gaseously connecting a source of compressed gas to the gas inlet. By “gaseously connecting” the source of compressed gas to the gas inlet, it is meant connecting the two elements such that gasses may be exchanged therebetween. As discussed above, any convenient source of compressed gas may be employed (e.g., gas compressor, gas canister, etc.). Methods may additionally involve operably connecting (e.g., gaseously connecting) one or more gas conduits to the source of compressed gas and the gas inlet. Each gas conduit may interface with a radial airflow path in the gas inlet, e.g., via press fit or any other suitable attachment mechanism including, but not limited to, clamps, magnets, latches, notches, countersinks, counter-bores, grooves, pins, tethers, hinges, non-permanent adhesives or a combination thereof. In some cases, the method comprises operably connecting a plurality of gas conduits to the source of compressed gas and the gas inlet.

Methods according to some embodiments also include operably connecting a processor to the source of compressed gas. As discussed above, processors of interest are configured to adjust the pressure of the produced gas provided to the gas inlet. The processor may or may not be a an already-existing processor within a particle sorter. Where the processor already exists in the particle sorter, the processor is modified (e.g., via a plug-in) to have the additional functionality of adjusting the source of compressed gas to provide a certain amount of pressure.

### Computer-Controlled Systems

Aspects of the invention additionally include computer-controlled systems, where the systems include one or more computers for complete automation or partial automation In some embodiments, systems include a computer having a non-transitory computer readable storage medium with a computer program stored thereon, where the computer program when loaded on the computer includes instructions for receiving a desired droplet size and/or volume (e.g., inputted by the user), and actuating a change in the source of compressed gas such that the desired droplet size and/or volume is realized.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor, or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, Python, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. In some embodiments, the processor includes analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, or a diskette drive. Such types of memory storage devices typically read from, and/or write to, a program storage medium (not shown) such as a compact disk. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, Wi-Fi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, a USB-C port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or Wi-Fi connection to the internet at a Wi-Fi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a workstation, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows® NT®, Windows® XP, Windows® 7, Windows® 8, Windows® 10, iOS®, macOS®, Linux®, Ubuntu®, Fedora®, OS/400®, i5/OS®, IBM i®, Android™, SGI IRIX®, Oracle Solaris® and others.

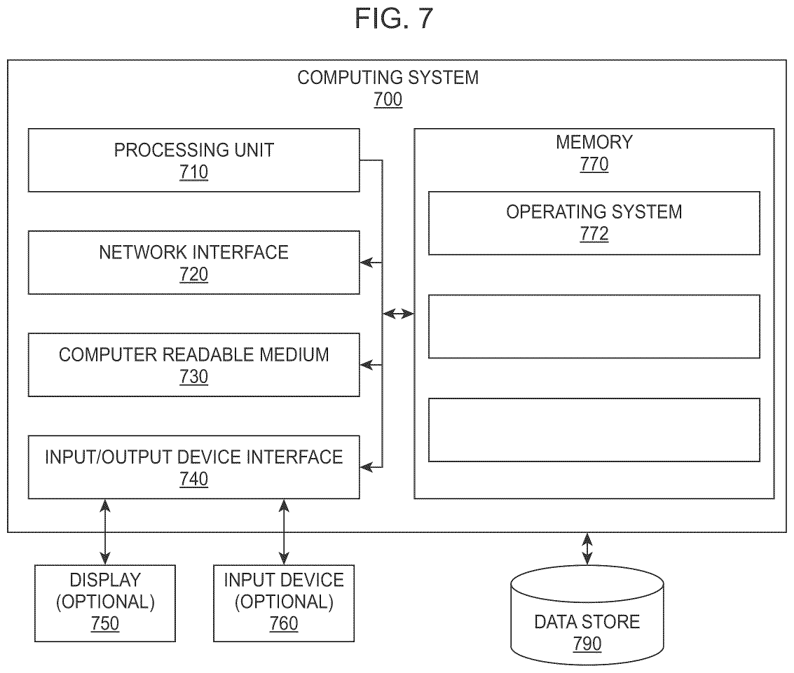

FIG. 7 depicts a general architecture of an example computing device 600 according to certain embodiments. The general architecture of the computing device 700 depicted in FIG. 7 includes an arrangement of computer hardware and software components. It is not necessary, however, that all of these generally conventional elements be shown in order to provide an enabling disclosure. As illustrated, the computing device 700 includes a processing unit 710, a network interface 720, a computer readable medium drive 730, an input/output device interface 740, a display 750, and an input device 760, all of which may communicate with one another by way of a communication bus. The network interface 720 may provide connectivity to one or more networks or computing systems. The processing unit 710 may thus receive information and instructions from other computing systems or services via a network. The processing unit 710 may also communicate to and from memory 770 and further provide output information for an optional display 750 via the input/output device interface 740. For example, an analysis software (e.g., data analysis software or program such as FlowJo®) stored as executable instructions in the non-transitory memory of the analysis system can display the flow cytometry event data to a user. The input/output device interface 740 may also accept input from the optional input device 760, such as a keyboard, mouse, digital pen, microphone, touch screen, gesture recognition system, voice recognition system, gamepad, accelerometer, gyroscope, or other input device.

The memory 770 may contain computer program instructions (grouped as modules or components in some embodiments) that the processing unit 710 executes in order to implement one or more embodiments. The memory 770 generally includes RAM, ROM and/or other persistent, auxiliary or non-transitory computer-readable media. The memory 770 may store an operating system 772 that provides computer program instructions for use by the processing unit 710 in the general administration and operation of the computing device 700. Data may be stored in data storage device 790. The memory 770 may further include computer program instructions and other information for implementing aspects of the present disclosure.

### Utility

The nozzles, cell sorters, methods and kits of the disclosure find use, for example, where it is desirable to adjust droplet sizes in a cell sorter without swapping nozzles. In addition, the invention may be employed where it is desirable to improve data received from particle-modulated light in a cell sorter by removing a source of perturbation that is upstream of the flow cell. Embodiments of the invention find use in applications where cells prepared from a biological sample may be desired for research, laboratory testing or for use in therapy. In some embodiments, the subject methods and devices may facilitate obtaining individual cells prepared from a target fluidic or tissue biological sample. For example, the subject methods and systems facilitate obtaining cells from fluidic or tissue samples to be used as a research or diagnostic specimen for diseases such as cancer. Likewise, the subject methods and systems may facilitate obtaining cells from fluidic or tissue samples to be used in therapy. Methods and devices of the present disclosure allow for separating and collecting cells from a biological sample (e.g., organ, tissue, tissue fragment, fluid) with enhanced efficiency and low cost as compared to traditional flow cytometry systems.

### Kits

Aspects of the invention additionally include kits. Kits of interest include the subject nozzle. As mentioned above, the subject nozzle includes an elongate body comprising an opening at a proximal end engaged in a liquid-receiving relationship with the flow cell, an opening at a distal end for emitting liquid droplets, and a channel configured to transport liquid through the elongate body from the proximal to the distal end. In addition, nozzles of the invention include a gas inlet radially positioned at the proximal end of the elongate body, wherein the gas inlet comprises a radial airflow path configured to provide a gas to the channel. Kits of interest may additionally include one or more gas conduits. In certain cases, kits include a plurality of gas conduits. In some instances, kits include a source of compressed gas. As discussed above, any convenient source of compressed gas may be employed (e.g., gas compressor, gas canister, etc.).

In some versions, kits additionally include a processor configured to adjust the pressure of the produced gas provided to the gas inlet. In other cases, kits include instructions for modifying an existing processor on a cell sorter to adjust the pressure of the produced gas provided to the gas inlet. Kits in some such cases include storage media such as a magneto-optical disk, CD-ROM, CD-R magnetic tape, non-volatile memory card, ROM, DVD-ROM, Blue-ray disk, solid state disk, and network attached storage (NAS). Any of these program storage media, or others now in use or that may later be developed, may be included in the subject kits. A plugin may be provided on the storage media for modifying the existing processor.

In addition to the above components, the subject kits may further include (in some embodiments) instructions, e.g., for installing the plugin to the existing software package. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, and the like. Yet another form of these instructions is a computer readable medium, e.g., diskette, compact disk (CD), portable flash drive, and the like, on which the information has been recorded. Yet another form of these instructions that may be present is a website address which may be used via the internet to access the information at a removed site.

The following example is offered by way of illustration and not by way of limitation.

### EXPERIMENTAL

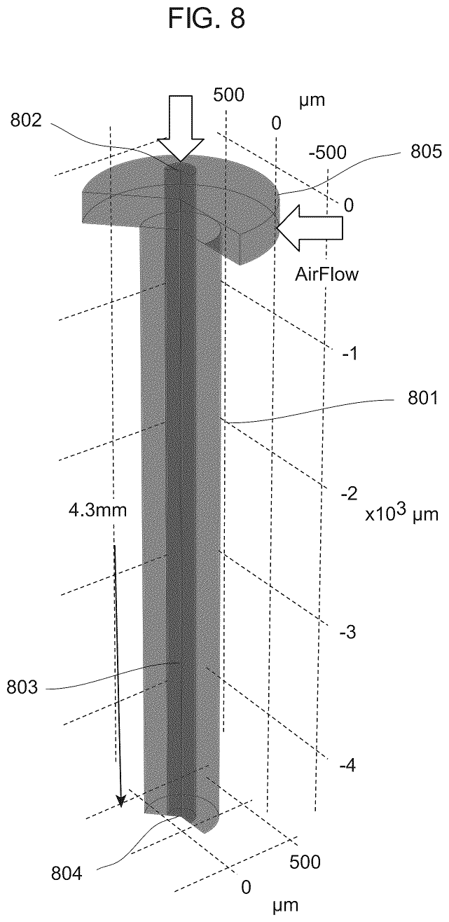

A simulation was carried out to demonstrate the working principle of employing a dispersed flow and a continuous flow to generate droplets periodically from a nozzle. The simulation was carried out using COMSOL® Multiphysics software. The simulated nozzle had a diameter of 200 μm, a radial airflow path of 200 μm in height, and extended cylinder of 500 μm in diameter and 4.3 mm in length. FIG. 8 provides a depiction of the simulated nozzle. As shown in FIG. 8, the nozzle includes an elongate body 801, an opening 802 at the proximal end for receiving liquid from a flow cell (not shown), a channel 803, an opening at the distal end for emitting liquid droplets 804, and a gas inlet 805. The volume flow rate through the simulated nozzle was set at 6.3 ml/min (105 μl/s).

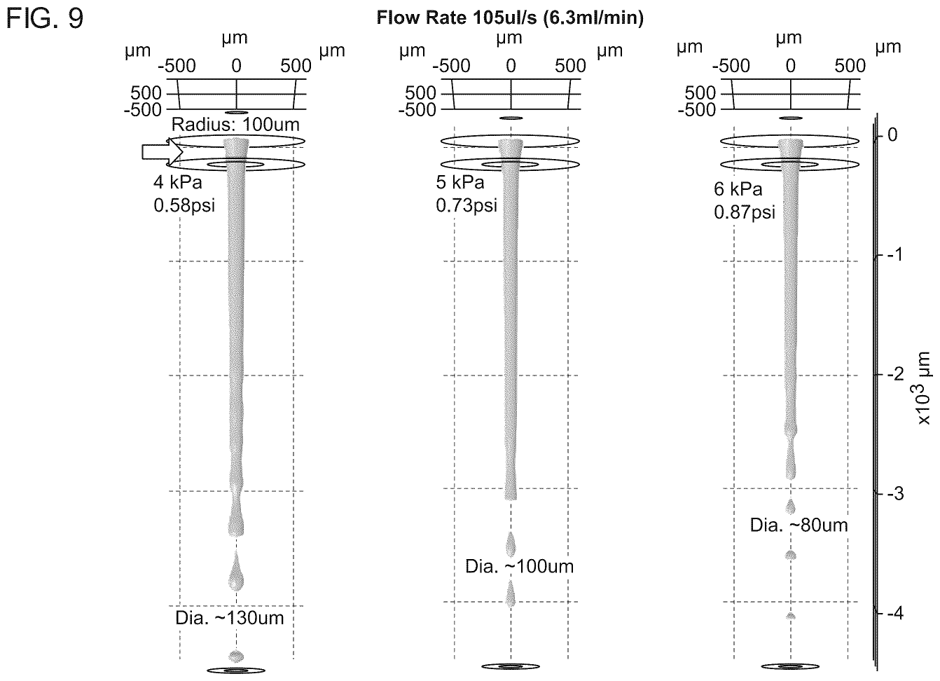

Three different simulations were carried out using the above-described nozzle. In each simulation, one of three air pressures was applied to gas inlet 805: 4 kPa (0.58 psi), 5 kPa (0.73 psi), and 6 kPa (0.87 psi). FIG. 9 depicts the results of these simulations. As shown in FIG. 9, the simulation carried out at 4 kPa resulted in droplets having a diameter of approximately 130 μm, the simulation carried out at 5 kPa resulted in droplets having a diameter of approximately 100 μm, and the simulation carried out at 6 kPa resulted in droplets having a diameter of approximately 80 μm. The results show that the droplet size can be adjusted by the inlet air pressure of the air flow.

Although the foregoing invention has been described in some detail by way of illustration and example for purposes of clarity of understanding, it is readily apparent to those of ordinary skill in the art in light of the teachings of this invention that some changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A particle sorter comprising:
a flow cell configured to transport particles in a flow stream; and
a nozzle comprising:
an elongate body comprising:
an opening at a proximal end engaged in a liquid-receiving relationship with the flow cell;
an opening at a distal end for emitting liquid droplets; and
a channel configured to transport liquid through the elongate body from the proximal to the distal end; and
a gas inlet radially positioned at the proximal end of the elongate body, wherein the gas inlet comprises a radial airflow path configured to provide a gas to the channel.

2. The particle sorter according to claim 1, wherein the radial airflow path comprises a height ranging from 150 μm to 250 μm.

3. The particle sorter according to claim 1, wherein the radial airflow path comprises a radius ranging from 200 μm to 300 μm.

4. The particle sorter according to claim 1, wherein the gas inlet comprises a plurality of radial airflow paths.

5. The particle sorter according to claim 4, wherein the number of radial airflow paths in the plurality of radial airflow paths ranges from 2 to 5.

6. The particle sorter according to claim 1, further comprising a source of compressed gas.

7. The particle sorter according to claim 6, wherein the source of compressed gas is an air compressor.

8. The particle sorter according to claim 6, wherein the source of compressed gas is configured to produce a gas having a pressure ranging from 2 kPa to 10 kPa.

9. The particle sorter according to claim 6, further comprising a gas conduit configured to operably connect the source of compressed gas to the gas inlet.

10. The particle sorter according to according to claim 9, wherein the particle sorter comprises a plurality of gas conduits.

11. The particle sorter according to claim 6, further comprising a processor operably connected to the source of compressed gas and configured to adjust the pressure of the produced gas provided to the gas inlet.

12. The particle sorter according to claim 1, wherein the channel comprises a diameter ranging from 150 μm to 250 μm.

13. The particle sorter according to claim 12, wherein the channel comprises a constant diameter throughout the length of the elongate body.

14. The particle sorter according to claim 1, wherein the elongate body is cylindrical in shape.

15. The particle sorter according to claim 1, wherein the length of the elongate body ranges from 4 mm to 4.5 mm.

16. The particle sorter according to claim 1, wherein the nozzle is not operably attached to a piezoelectric actuator.

17. The particle sorter according to claim 1, further comprising a light source configured to irradiate the flow stream at an interrogation point.

18. The particle sorter according to claim 17, further comprising a detector configured to collect particle-modulated light from the flow cell.

19. The particle sorter according to claim 1, further comprising a plurality of receptacles configured to receive the droplets emitted by the opening at the distal end of the elongate structure.

20. The particle sorter according to claim 19, further comprising deflection plates configured to deflect the droplets into a given receptacle in the plurality of receptacles.

21-93. (canceled)
